(19) United States
(12) Patent Application Publication
(10) Pub. No.: US 2011/0140387 A1
(43) Pub. Date: Jun. 16, 2011

(54) Suspension System for Chain-Driven or Belt-Driven Vehicles

(76) Inventors: Arnel Marcelo Andal, Las Pinas (PH); Pablito Tolentino, JR., San Pedro (PH); Allan Jay Razo Soriano, Morong (PH)

(21) Appl. No.: 12/635,709

(22) Filed: Dec. 11, 2009

(51) Int. Cl. B60G 3/20

(52) U.S. Cl. 280/124.133

(57) ABSTRACT

A suspension system wherein the pivots are aligned such that its anti-squat and anti-rise values are completely constant throughout suspension travel.

### BACKGROUND OF THE INVENTION

This invention relates generally to the field of suspension systems for chain-driven or belt-driven wheeled vehicles, particularly bicycles. Bicycle suspension systems are progressively becoming more elaborate as bicycles are being used on more demanding terrain. Several inventions were developed in order to address problems usually associated with such suspension systems.

U.S. Pat. No. 623,210 discusses a suspension configuration wherein the links are configured such that it's instantaneous center tracks the chain-line. This minimizes the effect of chain force on suspension movement. U.S. Pat. No. 7,566,066 configures the links to arrange the virtual pivot near the chain and the instant center in front of the chain. This gives favorable pedalling and braking characteristics. U.S. Pat. No. 7,128,329 manipulates the anti-squat parameter such that it changes to suit varying applications.

Suspension systems are measured by several parameters that characterize how it behaves at certain situations. These parameters include leverage ratio, wheel rate, chain growth, pedal kickback, anti-squat and anti-rise. Of these parameters, anti-squat and anti-rise are dependent on the instantaneous center of the rear wheel member, which means it depends mainly on the configuration of the suspension linkages.

With the three competing patents described above, as with most other suspension designs, consistency in anti-squat and anti-rise are either not addressed or are designed to vary with suspension travel. Anti-squat and anti-rise are dependent on factors such as the instant center position, center of mass and tire contact patch. All these factors vary as the suspension goes through its travel, making it difficult to maintain consistent anti-squat and anti-rise.

The current designs may have a desirable amount of anti-squat and anti-rise at certain point in travel, but begins to deviate from that desirable state as the suspension moves. Consistency enables the suspension to behave predictably.

By specific positioning of the pivots, a desired amount of constant anti-squat and anti-rise can be engineered.

The following discussions will be under the context of bicycles, but the invention can be applied to other vehicles with a similar configuration, including motorcycles, cars, etc.

### BRIEF DESCRIPTION OF DRAWINGS

FIG. 2 details how the value of anti-squat is calculated.

FIG. 3 details how the value of anti-rise is calculated.

FIG. 1 shows the components of the suspension system.

FIG. 4 shows the anti-squat and anti-rise curve of the suspension at constant 101% and 44% anti-squat and anti-rise, respectively

FIG. 5 details the lower link synthesis.

FIG. 6 shows that at compression, the level of anti-squat is the same.

FIG. 7 details the upper link synthesis.

FIG. 8 shows that at compression, the level of anti-rise is the same.

FIG. 9 shows the trace of the anti-squat isocurve and anti-rise isocurve. As long as the respective pivots is placed along the isocurves, consistency will be attained.

FIG. 10 shows one possible starting point for linkage synthesis.

FIG. 11 shows a certain embodiment of the invention with 100% anti-squat, 100% anti-rise, and with pivot near the axle.

FIG. 12 shows a certain embodiment of the invention with 100% anti-squat, 0% anti-rise, and with a small rear wheel member.

FIG. 13 shows a certain embodiment of the invention with 100% anti-squat, 109% anti-rise, with a short lower arm.

### SUMMARY OF THE INVENTION

As shown in FIG. 1, the invention is comprised of a lower arm (1a), an upper arm (1b) and a rear wheel member (1c). The lower arm and upper arm pivots on the main body of the vehicle by pivots 1d and 1e, respectivelt. Specific positioning of pivots (1d) and (1f) is the key to generating anti-squat and anti-rise curves that are consistent throughout the suspension travel. Different arm lengths and pivot positions are possible, just as long as the rear wheel member is connected only to the upper and lower arm, and not directly connected to the main body.

The invention makes it possible to design a suspension system with user selected amount of anti-squat and anti-rise and that is consistent throughout travel. FIG. 4 shows the anti-squat and anti-rise plots of a certain embodiment of the suspension with 101% anti-squat and 44% anti-rise. Any amount of anti-squat and anti-rise may be chosen for whatever purpose required. Having 0% anti-rise gives the feeling of floating brakes while 100% anti-rise gives neutral braking feel. Different amounts of anti-squat give different pedaling feel. What's important with is that these two parameters are constant throughout suspension travel. This gives the bike a consistent feel regardless whether the suspension is sagged in or compressed by a bump.

### DETAILED DESCRIPTION

### 1 Anti-Squat

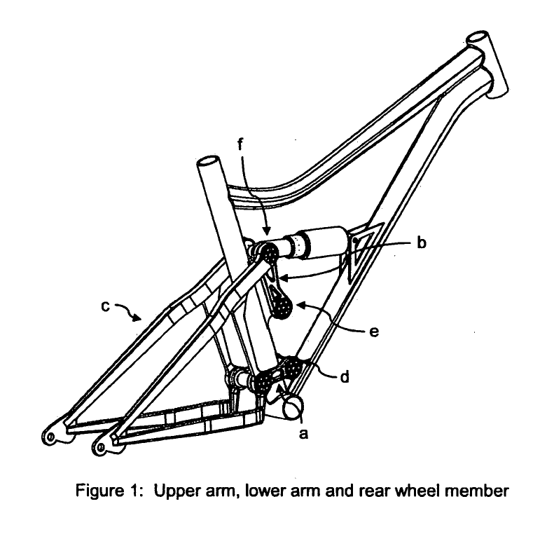

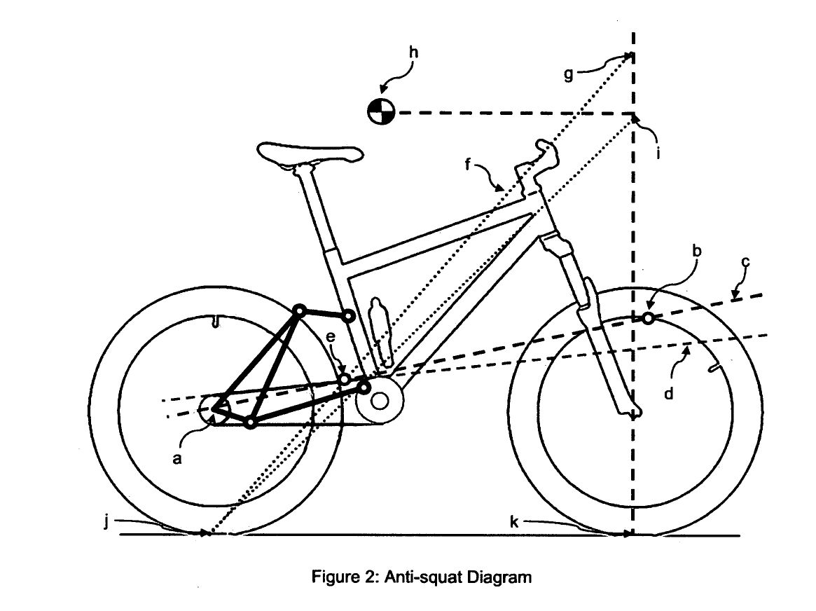

Anti-squat is described as a force that prevents the rear suspension from compressing due to weight transfer from acceleration. Bicycle suspensions have a natural tendency to compress or “squat” during acceleration. Having 100 percent anti-squat means that the suspension is able to totally counter the squatting force. The amount of anti-squat is calculated based on the diagram in FIG. 2.

Line 1 (2c) is defined by the rear axle (2a) and the current instantaneous center (2b). Line 2 is the chain force line (2d). The intersection of line 1 and line 2 defines point (2e). The line of anti-squat (2f) is defined by the rear tire contact patch (2j) and point (2e). The intersection of the anti-squat line and the vertical line from the front tire contact patch defines point (2g). The distance from point (2k) to point (2g) defines the amount of anti-squat. The percentage of anti-squat is measured from height (2i) which is at the same height as the center of gravity of the vehicle (2h). Percentage anti-squat is calculated as [gk/ik×100%]

Notice that the for the suspension shown in FIG. 2, anti-squat is greater than 100% and the suspension will have a tendency to extend. Note that since the instantaneous center position, rear tire contact patch and center of mass varies over the suspension travel range, the value of anti-squat varies as well.

### 2 Anti-Rise

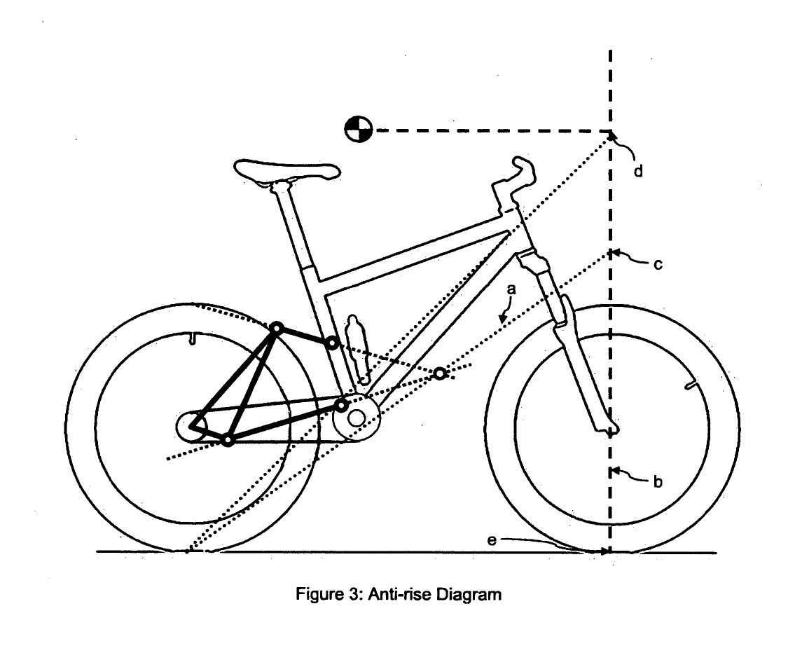

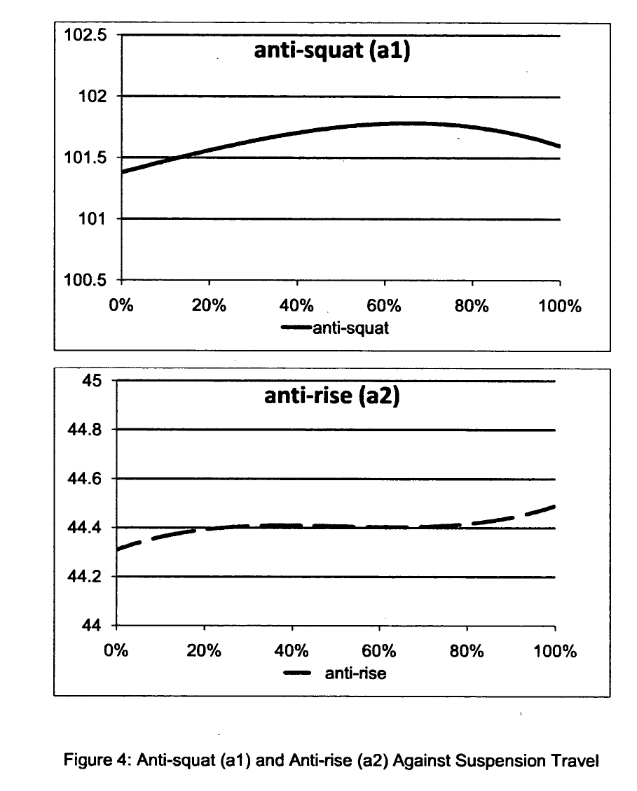

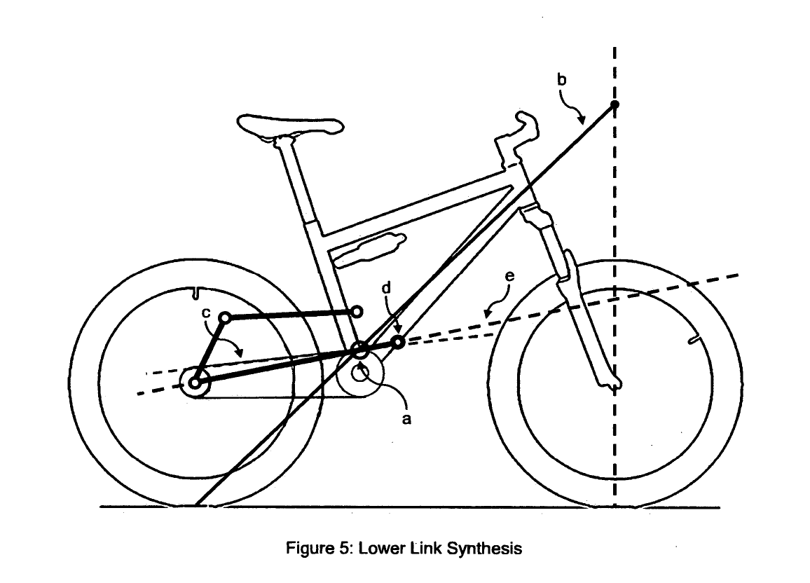

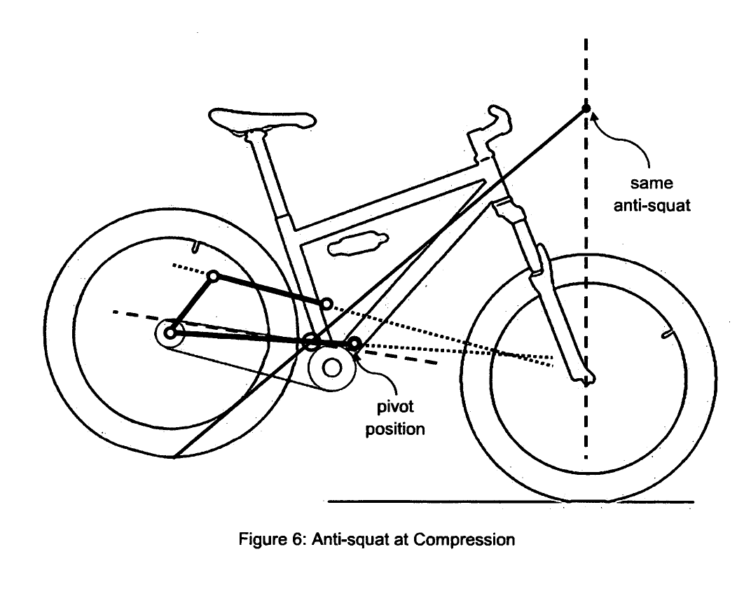

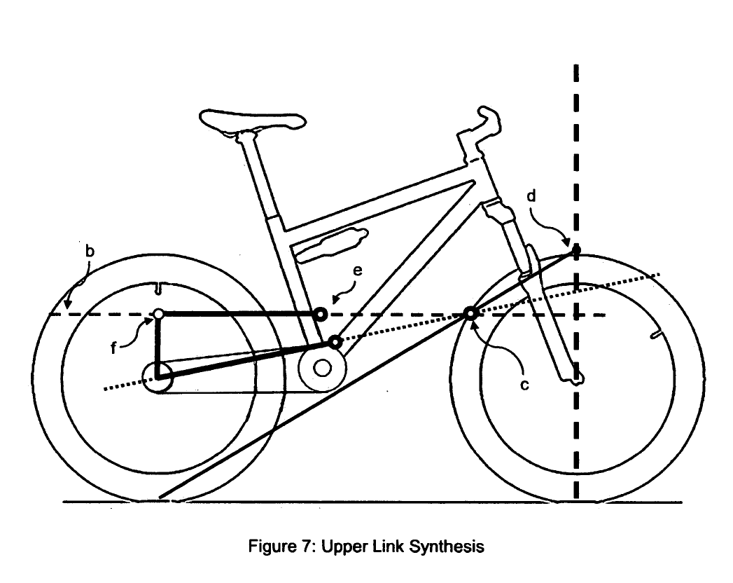

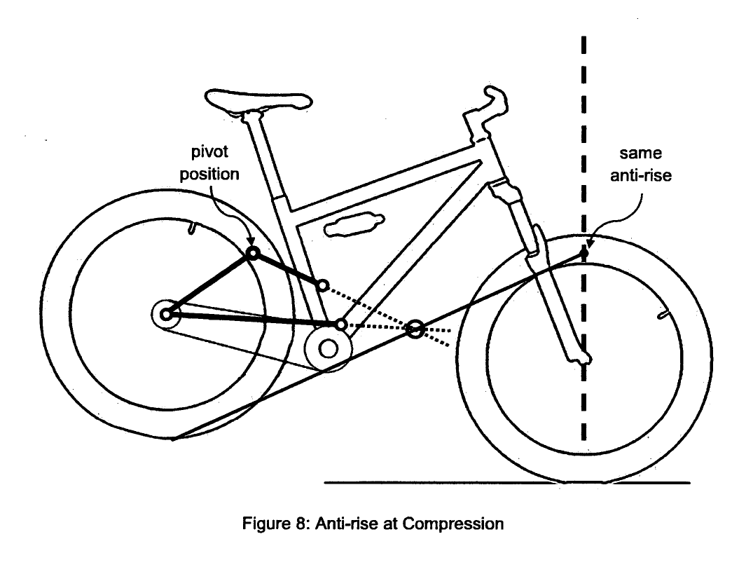

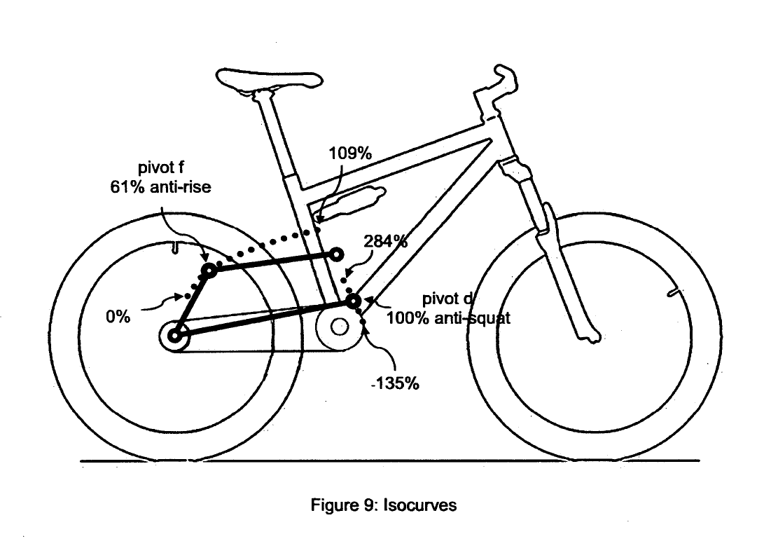

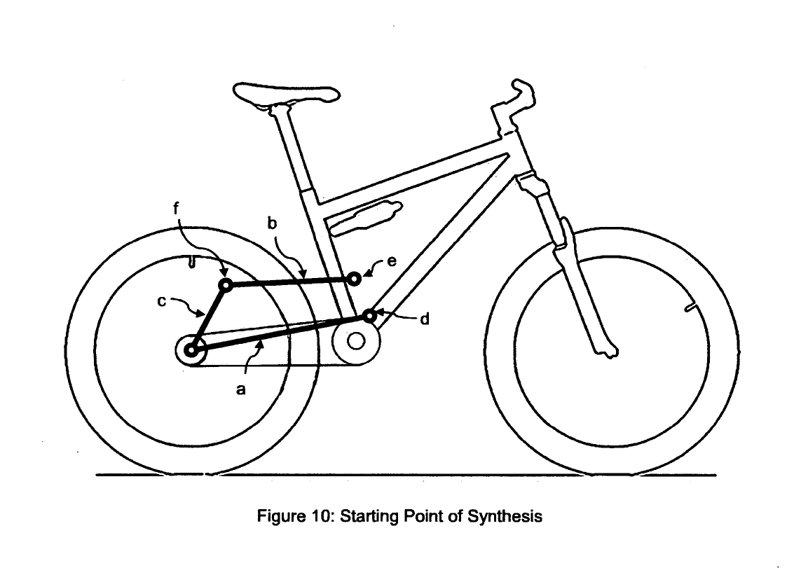

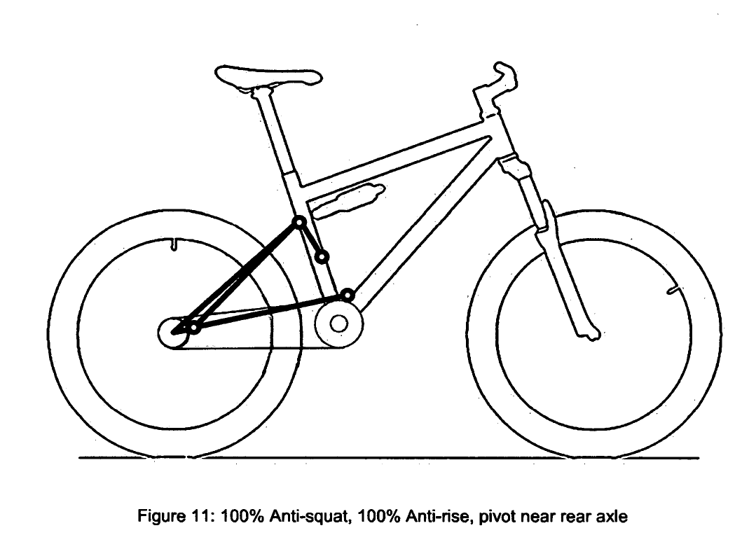

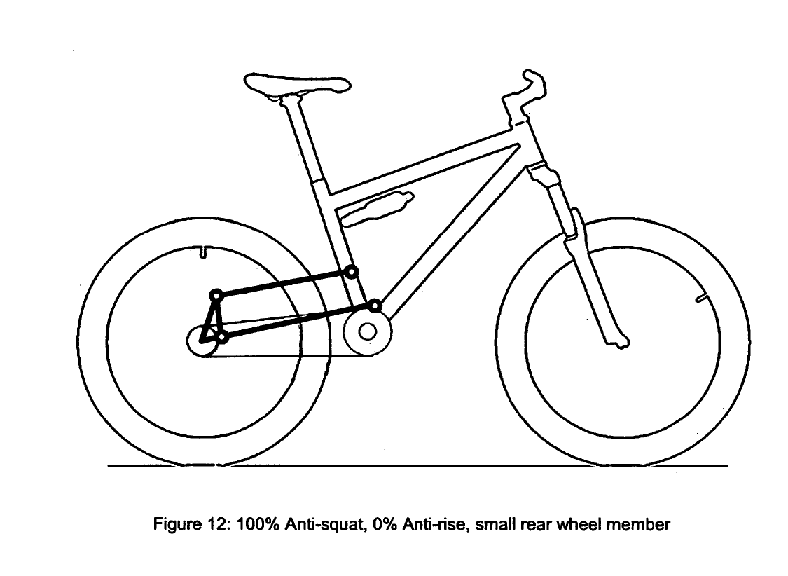

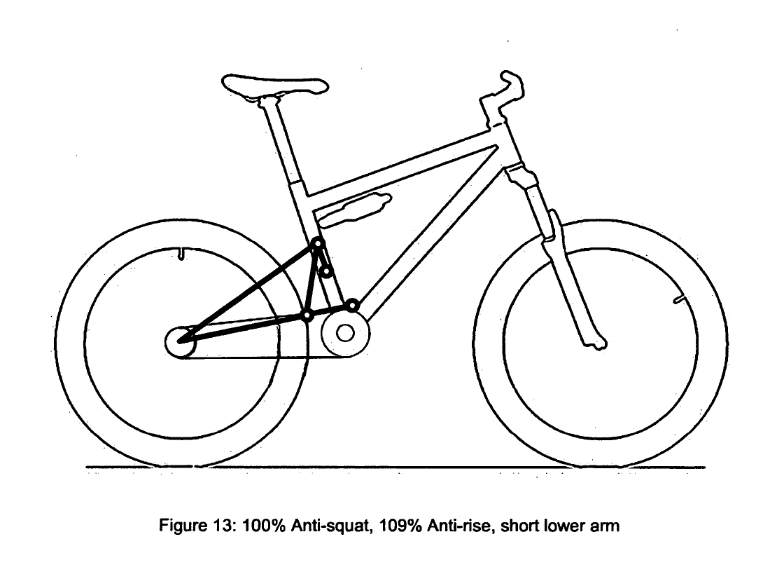

Anti-rise is similar to the concept of anti-squat where it counters forces that tend to cause the rear suspension to extend due to braking forces exerted on the tire. The amount of anti-rise is calculated based on the diagram in FIG. 3.

Simply put, it is the impression of the rear-wheel-patch-to-IC line (3a) on line (3b). Percentage anti-rise is calculated as [ce/de×100%]

A 100% anti-rise means that the suspension will neither compress nor extend due to braking. Some prefer suspension that is free to extend during braking and employ floating disc brake calipers to reduce anti-rise down to 0%.

### 3 Assumptions

The computations for anti-squat and anti-rise as discussed previously are based on several assumptions that may not hold in actual practice especially on bicycles. The center of mass is assumed to be at a fixed point. In reality, movements by the rider such as standing up or leaning forward will affect the center of mass. The compression of the front fork will lower the center of mass as well. Also, anti-squat calculations are dependent on a specific chain line, and since most bicycles are geared, this chain line varies with changing sprocket combinations. These are just a few of the limitations of the anti-squat and anti-rise model described.

Designs based on anti-squat and anti-rise are based on “average” or “frequent” values. An “average chain torque line” or ACTL is assumed for the chain line, while the center of mass is assumed at the rider's usual position. The exact value of anti-squat and anti-rise is compounded by many factors and it is not possible to account all of them in suspension linkage design. However, it is often adequate enough to refer to the simplified anti-squat/anti-rise model and use average/frequent values since the effects of the other factors are often negligible.

### 4 Lower Link Synthesis

The lower link is the one that determines the amount of anti-squat generated. The design of the lower link (1d) is detailed in FIG. 5. Point 5a is defined by the intersection of the desired anti-squat line (5b) and chain line (5c). Line 5e is defined by the rear axle and point 5a. The lower link pivot 5d is chosen such that the instant center lies along this line.

The exact location of the lower link pivot on line 5e is determined as shown in FIG. 6 The pivot position that gives the same anti-squat when the suspension is compressed or extended defines the lower link.

### 5 Upper Link Synthesis

The upper link is the one that determines the amount of anti-rise generated. The design of the upper link is similar in procedure to that of the lower link, and is detailed in FIG. 7. Pivot 7e is free to be placed anywhere, usually on the seat tube, where it is more convenient. Line 7b passes through pivot 7e and points to the instant center 7c that determines the desired amount of anti-rise (7d). Pivot 7f is placed along this line.

Just like the lower link synthesis, the exact location of pivot 7f on line 7b is determined as shown in FIG. 8. The final position of pivot 7e is where anti-rise is the same with the suspension compressed or extended.

### 6 Isocurves

It is possible to plot the specific locations of pivots 9d and 9f for every value of anti-squat and anti-rise. The plot will trace out distinct curves which will be referred to as isocurves. FIG. 9 shows the isocurve plot for the particular linkage configuration.

The anti-squat isocurve trace out the positions of pivot 9d that will yield a specific value of anti-squat. Similarly, the anti-rise isocurve is for pivot 9f. As long as the pivots lie on this curve, anti-squat and anti-rise will be consistent throughout travel.

Take note, however, that the two isocurves are not independent of each other. Moving pivot 9d may change the anti-rise isocurve, and vise-versa for pivot 9f for the anti-squat isocurve. Thus, in linkage synthesis, the pivots are located one at a time. Pivot 9d is placed first on the anti-squat isocurve, and then the anti-rise isocurve is generated. After placing pivot 9f on the anti-rise isocurve, it may be necessary to check the anti-squat isocurve if it has changed in the process.

### 7 Variations of the Invention

The linkage configuration shown in FIG. 10 is just one possible starting point for linkage synthesis. Many other configurations will also yield isocurves from the same process discussed in the previous sections.

A certain configuration may be preferred over another for practicality. For example, pivot 10e may be placed absolutely anywhere, but it is just practical to mount it on the seat tube.

In FIG. 10, the rear axle acts as a fourth pivot. But for reasons of mechanical complexity, it is possible to move the pivot to be simply near the rear axle. It is even possible to move that pivot outside of the rear wheel area in order to unify the pivot (rather than being split into two by the wheel in the middle). Note, however, that a shorter lower arm will yield consistent antisquat for shorter amounts of travel. This may be desirable if an anti-squat that “dies off” at towards the end of travel is wanted.

FIGS. 11 to 13 shows several embodiments of the suspension.

We claim:

1. A vehicular suspension including a driven wheel suspension comprising a lower arm with one pivot on the main frame (Pivot A), upper arm with pivot on the mainframe (Pivot B), rear wheel member with pivots on the lower arm (Pivot C) and upper arm (Pivot D), wherein the improvement comprises an upper arm an lower arm as arranged so that the force lines through the pivots of the each arm intersect at an Instant Center, and where Pivot A is positioned such that the point of intersection of the Chain Line and a user-selected Anti-Squat line lies to within ±5 mm of the line drawn from the Rear Axle to the derived Instant Center for at least 85% to 100% of the suspension travel.

2. A vehicular suspension including a driven wheel suspension as claimed in claim 1 wherein the improvement comprises a Pivot D positioned such that the Instant Center lies within ±5 mm of the user-selected Anti-Rise line throughout the suspension travel.

3. A vehicular suspension including a driven wheel suspension as claimed in claim 1 and claim 2 wherein the two (2) suspensions are made to function together to provide the user-selected Anti-Squat and user-selected Anti-Rise properties in one system.

4. A vehicular suspension including a chain-driven or belt-driven wheel suspension as claimed in claim 1, wherein the suspension system is useful for a chain-driven or belt-driven vehicle.

5. A vehicular suspension including a driven wheel suspension as claimed in claim 1, wherein a damper unit is connected to the upper arm.

6. A vehicular suspension including a driven wheel suspension as claimed in claim 1, wherein the damper unit is connected to the rear wheel member.

7. A vehicular suspension including a driven wheel suspension as claimed in claim 1, wherein the damper unit is connected to upper and lower arm.

8. A vehicular suspension including a driven wheel suspension as claimed in claim 1, wherein the damper unit is selected from the group consisting of a spring, a compression gas spring, a leaf spring, a coil spring and a fluid, or any combination thereof.

9. A vehicular suspension including a chain-driven or belt-driven wheel suspension as claimed in claim 2, wherein the suspension system is useful for a chain-driven or belt-driven vehicle.

10. A vehicular suspension including a driven wheel suspension as claimed in claim 2, wherein a damper unit is connected to the upper arm.

11. A vehicular suspension including a driven wheel suspension as claimed in claim 2, wherein the damper unit is connected to the rear wheel member.

12. A vehicular suspension including a driven wheel suspension as claimed in claim 2, wherein the damper unit is connected to upper and lower arm.

13. A vehicular suspension including a driven wheel suspension as claimed in claim 2, wherein the damper unit is selected from the group consisting of a spring, a compression gas spring, a leaf spring, a coil spring and a fluid, or any combination thereof.

14. A vehicular suspension including a chain-driven or belt-driven wheel suspension as claimed in claim 3, wherein the suspension system is useful for a chain-driven or belt-driven vehicle.

15. A vehicular suspension including a driven wheel suspension as claimed in claim 3, wherein the suspension is useful for human powered vehicle or motor-powered vehicle.

16. A vehicular suspension including a driven wheel suspension as claimed in claim 3, wherein a damper unit is connected to the upper arm.

17. A vehicular suspension including a driven wheel suspension as claimed in claim 3, wherein the damper unit is connected to the lower arm.

18. A vehicular suspension including a driven wheel suspension as claimed in claim 3, wherein the damper unit is connected to the rear wheel member.

19. A vehicular suspension including a driven wheel suspension as claimed in claim 3, wherein the damper unit is connected to upper and lower arm.

20. A vehicular suspension including a driven wheel suspension as claimed in claim 3, wherein the damper unit is selected from the group consisting of a spring, a compression gas spring, a leaf spring, a coil spring and a fluid, or any combination thereof.
